(19) United States
(12) Patent Application Publication
(10) Pub. No.: US 2010/0166383 A1
(43) Pub. Date: Jul. 1, 2010

(54) SYSTEM AND METHOD FOR PROVIDING TRICK MODES

(75) Inventor: Anurag Goel, Panchkula (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/346,912

(22) Filed: Dec. 31, 2008

(51) Int. Cl. H04N 5/91

(52) U.S. Cl. 386/68; 386/E05.001

(57) ABSTRACT

A system and method for providing trick modes uses a trick mode video bitstream generated from an original video bitstream to produce video frames during a trick mode. The trick mode video bitstream is generated to be less complex with respect to decoding than the original video bitstream. Thus, the computational cost to provide trick modes is significantly lowered.

Personal video recorders (PVRs) are devices that allow video bitstreams to be recorded on a storage medium, such as a computer hard drive, which can be played at anytime by users. Users of PVRs are generally interested in browsing/seeking through the supplied content in various ways, such as fast forward, rewind, pause, freeze, frame stepping etc. These different browsing/seeking modes are commonly referred to as trick modes. Trick modes are important features for multimedia consumers, and thus, providing an efficient quality trick mode solution is of great commercial importance to set-top box manufacturers and service providers.

Latest video coding standard, i.e., H.264, is capable of compressing videos at half the file size at same video quality as compared to its predecessor video coding standard, i.e., MPEG4 (Motion Picture Experts Group 4). However, this comes at an increased computational cost of decoding video content due to the predictive coding used in H.264 codecs. Thus, it is a challenge to provide a good quality trick mode solution for high definition H.264 bitstreams within the available computation budget.

There are several conventional techniques that are widely used in the industry for implementing trick modes. One of the conventional techniques is to drop frames of certain type from the video decoding cycle, hence maintaining a high decode frame rate. For example, B frames (bidirectional coded frames) of a video bitstream may be dropped since these frames may not be reference frames. Another conventional technique is to start decoding only the intra coded portions (macroblocks) of the video bitstream and the predictive macroblocks of subsequent frames which depend on these intra coded portions, when the frame index in the video bitstream is approximately few frames before the desired frame to be displayed and to display a frame only when the entire frame contains data decoded from the collected intra blocks. Another conventional technique is to decode and display only I frames (intra coded frames) in the video sequence.

Users generally desire the change in video content to correspond to trick mode speed, i.e., a high decode rate and uniform display rate. This places a requirement on dropping frames from the decode cycle because of limited computation budget. However, for some video coding standards such as H.264, it is not possible to drop frames from the decoding cycle as all type of frames can depend on one another. Hence, it is not possible to maintain a high uniform display rate. Therefore, some conventional trick mode techniques resort to using non-uniform display rate in such cases. However, in some cases, such as extremely low intra content in the video sequence, it might be difficult to maintain even a non-uniform display rate.

In view of the above concerns, there is a need for a system and method for providing trick modes that does not require a high computational cost and/or a non-uniform display rate.

A system and method for providing trick modes uses a trick mode video bitstream generated from an original video bitstream to produce video frames during a trick mode. The trick mode video bitstream is generated to be less complex with respect to decoding than the original video bitstream. Thus, the computational cost to provide trick modes is significantly lowered.

A system for providing trick mode in accordance with an embodiment of the invention comprises a trick mode bitstream generator, a storage device, a decoder unit and a mode controller. The trick mode bitstream generator is configured to generate a trick mode video bitstream from an original video bitstream. The trick mode video bitstream is of lower complexity with respect to decoding than the original video bitstream. The storage device is used to store the original video bitstream and the trick mode video bitstream. The decoder unit is connected to the storage device to receive both the original video bitstream and the trick mode bitstream to produce decoded video frames to be displayed. The decoder unit is configured to decode only the original video bitstream to produce the decoded video frames during a normal play mode. The decoder unit is further configured to decode the trick mode video bitstream and a portion of the original video bitstream to produce the decoded video frames during a trick mode. The mode controller is connected to the decoder unit to control the decoder unit to decode according one of the normal play mode and the trick mode in response to user input.

A method for providing trick mode in accordance with an embodiment of the invention comprises generating a trick mode video bitstream from an original video bitstream, the trick mode video bitstream being of lower complexity with respect to decoding than the original video bitstream, decoding only the original video bitstream during a normal play mode to produce normal video frames to be displayed, and decoding the trick mode video bitstream and a portion of the original video bitstream during a trick mode to produce trick mode video frames to be displayed.

A method for providing trick modes in accordance with another embodiment of the invention comprises generating a trick mode video bitstream from an original video bitstream, the trick mode video bitstream being of lower complexity with respect to decoding than the original video bitstream, decoding only the original video bitstream during a normal play mode to produce normal video frames to be displayed, and decoding predictive frames of the trick mode video bitstream and independent reference frames of the original video bitstream during a trick mode to produce trick mode video frames to be displayed.

Other aspects and advantages of the present invention will become apparent from the following detailed description, taken in conjunction with the accompanying drawings, illustrated by way of example of the principles of the invention.

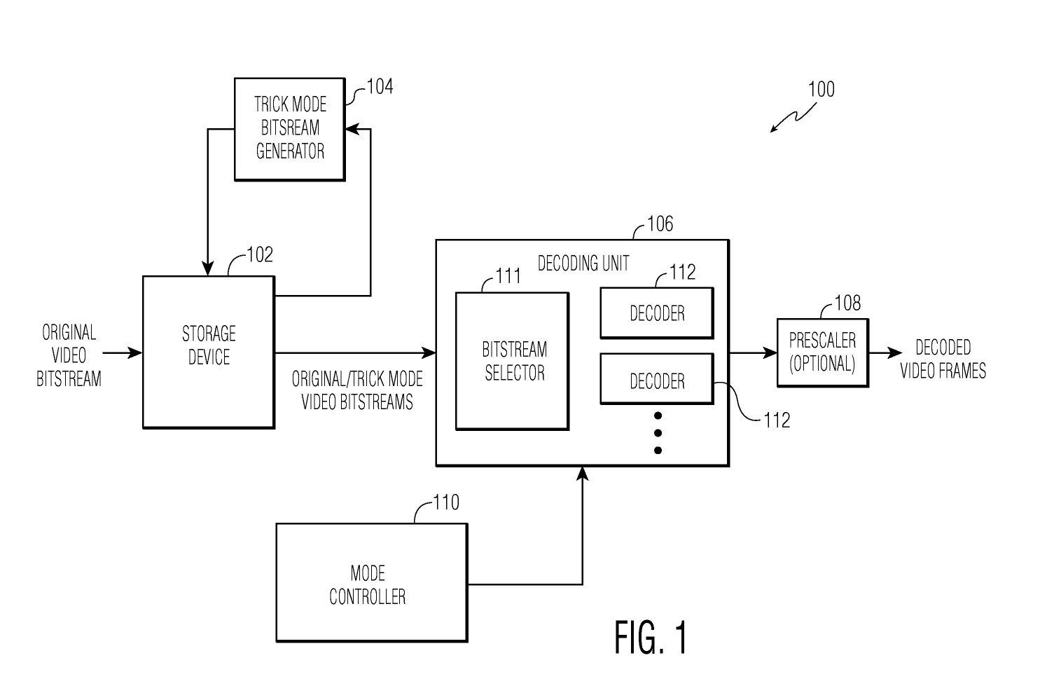

FIG. 1 is a block diagram of a system for providing trick modes in accordance with an embodiment of the invention.

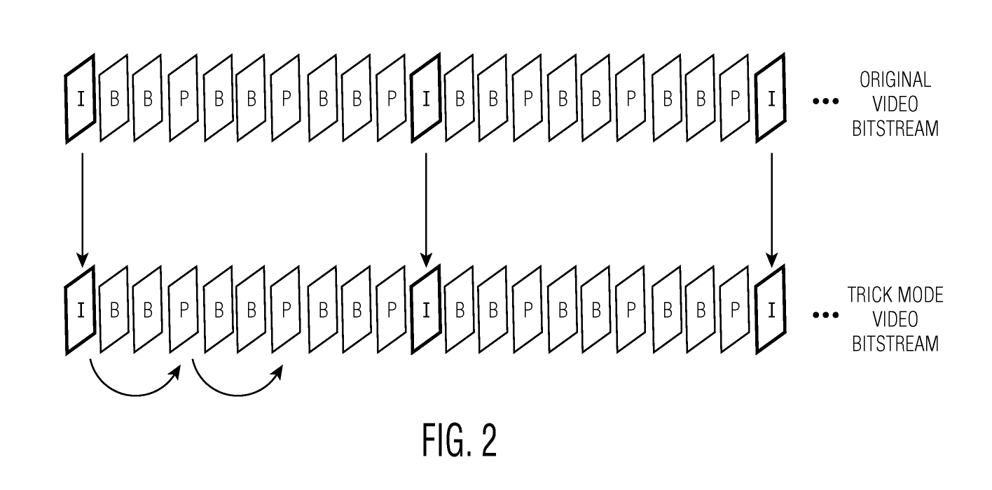

FIG. 2 illustrates the dependence of a trick mode video bitstream, which is generated in the system of FIG. 1, on an original video bitstream in accordance with an embodiment of the invention.

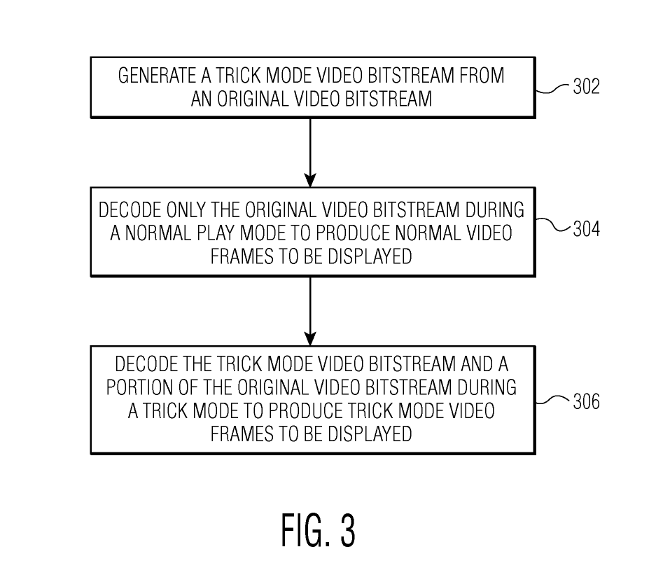

FIG. 3 is a process flow diagram of a method for providing trick modes in accordance with an embodiment of the invention.

With reference to FIG. 1, a system 100 for providing trick modes in accordance with an embodiment of the invention is described. As described in more detail below, the system 100 utilizes a low complexity trick mode bitstream to reduce the computational requirements to provide trick modes for a high decoding complexity video bitstream. In addition, the system 100 does not drop desired frames (frames to be decoded depending on trick mode speed) of the video bitstream during trick modes, which allows a uniform display rate to be maintained during the trick modes.

As illustrated in FIG. 1, the system 100 includes a storage device 102, a trick mode bitstream generator 104, a decoding unit 106, an optional prescaler 108 and a mode controller 110. The storage device 102 is used to store received original video bitstream, which may be encoded using any coding scheme. As an example, the received video bitstream may be a video bitstream coded according to H.264 coding standard. The storage device 102 is also used to store a low complexity trick mode video bitstream, which is created from the original video bitstream by the trick mode bitstream generator 104. The low complexity trick mode video bitstream is used when a user selects a trick mode, as described in more detail below. The storage device 102 can be any type of memory, such as a computer hard disk drive device or a flash memory device.

The trick mode bitstream generator 104 is connected to the storage device 102 to receive the original video bitstream stored in the storage device. The trick mode bitstream generator 104 is configured to generate the trick mode video bitstream from the original video bitstream. The trick mode video bitstream is a video bitstream having a lower complexity with respect to decoding as compared to the original video bitstream. The trick mode bitstream generator 104 operates to create the low complexity trick mode video bitstream in one or both of the following ways. One of the two ways to create the low complexity trick mode video bitstream is by encoding the low complexity trick mode video bitstream at a lower resolution than the original video bitstream. As an example, if the low complexity trick mode video bitstream is encoded at half the resolution of the original video bitstream, both the bit rate and the decoding complexity are reduced approximately by a factor of four. The other way to generate the low complexity trick mode video bitstream is to code the trick mode video bitstream according to a video coding format that is less complex as compared to the video coding format of the original video bitstream. For example, if the video coding format of the original video bitstream is H.264, then the low complexity trick mode video bitstream can be MPEG2 (Motion Picture Experts Group 2), VC-1 (Society of Motion Picture and Television Engineers 421M video codec standard), AVS (Audio Video Standard) or other suitable video coding format of lower complexity than H.264.

The trick mode bitstream generator 104 is also configured to create the low complexity trick mode video bitstream to minimize the file size of the trick mode video bitstream. Video content which gets coded using intra compression techniques takes a significant number of bits, which is also present in the predictive frames, i.e., the P frames (predictive coded frames) and B frames (bidirectional coded frames), of the coded video bitstream. Such video content is generally termed as “intra content.” The intra content of the low complexity video bitstream is obtained from the intra content of the original video frame. In particular, macroblocks of the independent reference I frames (intra coded frames) of the original video bitstream are decoded and downsampled. A macroblock, in YCbCr 4:2:0 color format, is a square region of 16×16 luminance pixels (Y), and a square region of 8×8 for each of the chrominance pixels (Cb and Cr). The downsampled reconstructed I frames become the I frames of the trick mode video bitstream. Hence, it is not required to place I frames in the trick mode video bitstream. Only I frame headers are placed in the trick mode bitstream which allow random access and switching between the original and trick mode bitstreams.

The predictive frames, i.e., the P and B frames, of the trick mode video bitstream are coded with respect to the downsampled reconstructed I frames obtained from the original video bitstream. This prediction can be termed as “inter bitstream prediction”. These reconstructed and downsampled intra frames from the original video bitstream become the reference frames for the predictive P and B frames of the low complexity trick mode video bitstream. In this manner, most of the intra content is avoided in the trick mode video bitstream, which leads to a higher compression rate for the trick mode video bitstream, and thus, minimizes the file size of the trick mode video bitstream.

The dependence of the trick mode video bitstream on the original video bitstream is illustrated in FIG. 2. As shown in FIG. 2, the I frames of the trick mode video bitstream are directly obtained from the I frames of the original video bitstream. As also shown in FIG. 2, the predictive P frames of the trick mode bitstream are dependent on the I frames of the trick mode video bitstream. The frames of the original and trick mode video bitstreams are illustrated in FIG. 2 in the display order.

A method of generating the low complexity trick mode video bitstream that is dependent on the original video bitstream in accordance with an embodiment of the invention involves decoding an I frame of the original video bitstream and then downsampling the reconstructed I frame of the original video frame so that the downsampled reconstructed I frame matches the resolution of the trick mode video bitstream. The downsampled reconstructed I frame is then deblocked to filter out blocking artifacts. The P and B frames of the original video frame are then reconstructed, downsampled and deblocked. These reconstructed, downsampled and deblocked frames are encoded as P and B frames of the trick mode video bitstream with respect to the reconstructed, downsampled and deblocked I frame of the original video bitstream. Time stamps of video frames of the original bitstream are used to time stamp the corresponding frames of the trick mode bitstream.

In an embodiment, the trick mode bitstream generator 104 is configured to create the trick mode video bitstream as a separate video bitstream from the original video frame. In this embodiment, the trick mode video bitstream and the original video frame are stored in the storage device 102 as two separate video bitstreams. In this embodiment, downsampled and deblocked I frames of original video bitstream are re-encoded for insertion into the trick mode video bitstream; hence they are independent of each other. In another embodiment, the trick mode bitstream generator 104 is configured to create the trick mode video bitstream and integrate the trick mode video bitstream into the original video frame to produce a composite video bitstream that includes both the trick mode video bitstream and the original video bitstream. As an example, the trick mode video bitstream may be multiplexed with the original video bitstream in the composite video bitstream, where methods of multiplexing may correspond to creation of PES (packetized elementary stream)/TS(Transport Stream)/PS (Program Stream) streams as described in ISO/IEC 13818-1. Thus, in this embodiment, the trick mode video bitstream and the original video frame are stored in the storage device 102 as a single video bitstream.

In an embodiment, the trick mode bitstream generator 104 is configured to create the trick mode video bitstream as a multi-codec video bitstream. A multi-codec video bitstream is a bitstream that is encoded using different coding formats, where some of the frames are coded using one coding format and the rest are coded using another coding format. For example, one GOP (Group of Pictures) is coded using one coding format and the alternate GOPs are coded using another coding format. Availability of two decoded GOPs in memory allows decoding of two GOPs in parallel by two independent decoders, hence increasing the decode rate by 2×. Another example is to code one set of alternate frames of a GOP in one coding format and another set of alternate frames of a GOP in another coding format. Preferably, for a GOP structure of type IBBP, where I, B and P are different frame types, if more than one frame is coded with respect to same reference frames, then such frames can be decoded in parallel and hence are coded in another coding format as compared to the coding format of the reference frames. For example, the independent reference I frames are coded using one coding format and the non-reference predictive B and P frames are coded using another coding format. Decoding rate is increased if a video bitstream is coded as a multi-codec video bitstream. Since high decoding rate is desired for trick modes, the low complexity trick mode video bitstream can also be encoded to be a multi-codec video bitstream. The trick mode video bitstream may be created and stored as a single multi-codec video bitstream or as multiple multi-codec video bitstreams. As an example, bitstreams of each codec of multi-codec video bitstreams may be multiplexed with each other, where methods of multiplexing may correspond to creation of PES/TS/PS streams as described in ISO/IEC 13818-1.

In an embodiment, for a single multi-codec video bitstream, a new data header (Multi_Codec_Data_Header) is introduced after the last frame of a particular codec. A unique identifier such as a unique start code is used to identify this data header. Start codes are generally a 4 byte data of following type, 0×000001bb (in hexadecimal notation), where bb is an 8 bit number which corresponds to a particular start code. The portion 0×00000 is generally termed as a start code prefix and is used to identify the presence of a start code. This start code will be unique in this entire bitstream. Elements of the new Data Header (Multi_Codec_Data_Header) include the following:

1. unique identifier such as a unique start code, and

2. codec type.

As an example, the multi-codec video bitstream may have the following format:
Frames_and_Headers_of_Codec1-Multi-Codec2_Data_Header -Frames_and_Headers_of_Codec2-Multi_Codec1_Data_Header-Frames_and_Headers_of_Codec1. In decode, the order of the bitstream may be as follows: Codec1_Data-Headers-I frame-P frame -Multi_Codec2_Data_Header-Codec2_Data_Headers-B frame-B frame-Multi_Codec1_Data_Header-Codec1_Data_Headers- P frame-Multi_Codec2_Data_Header-Codec2_Data_Headers-P frame-B frame-B frame-Multi-Codec1_Data_Header-Codec1_Data_Headers-I frame-P frame.

When a multi-codec video bitstream is being decoded, reference frames decoded using a particular video format are not flushed and are used to decode subsequent frames, which are coded in a different video format.

In an embodiment, the multi-codec trick mode video bitstream is created and stored as multiple multi-codec bitstreams. In this embodiment, bitstreams of each codec type are stored separately. A bitstream of reference frames is generated using one video coding format. A bitstream of non-reference frames is generated using another video coding format. A table that indicates how many frames of one codec are present after a frame of another codec and location of such frames is used to traverse both the bitstreams. Alternatively, the same information as to how many frames of one codec are present after a frame of another codec can be incorporated in the bitstream of the first video format by introducing a new data header (Multi_Codec_Data_Header). Frames are appropriately chosen from both bitstreams and sent to the decoding unit 106 in appropriate order. When a multi-codec bitstream is being decoded, reference frames decoded using a particular video format are not flushed and are used to decode subsequent frames, which are coded in a different video format. Elements of the new Data Header (Multi_Codec_Data_Header) include the following:

1. unique identifier such as a unique start code,

2. codec type, and

3. number of frames of another codec.

The decoding unit 106 is connected to the storage device 102 to access the original and trick mode video bitstreams for normal play mode, as well as for trick modes. During a normal play mode (1× speed), the decoding unit 106 decodes only the original video bitstream to produce video frames to be displayed for normal play. During a trick mode, the decoding unit 106 decodes the trick mode video bitstream and at least some of the original video bitstream to produce video frames to be displayed for the trick mode, which could be fast forward, rewind, etc. Since the trick mode video bitstream is less complex than the original video bitstream with respect to decoding, the use of the trick mode video bitstream allows the decoding unit to decode more efficiently to provide trick modes selected by a user.

As shown in FIG. 1, the decoding unit 106 includes a bitstream selector 111 and at least one decoder 112. The bitstream selector 111 receives both the original video bitstream and the trick mode video bitstream to selective decode the required frames of the video bitstreams to provide either a normal play mode or one of the trick modes. During a normal play mode, the bitstream selector 111 transmits the original video bitstream to at least one of the decoders 112 of the decoding unit 106. If the original video bitstream is a single codec video bitstream, then the original video bitstream may be decoded using a single decoder 112 in the decoding unit 106. However, if the original video bitstream is a multi-codec video bitstream, then the original video bitstream may be decoded using multiple decoders 112 in the decoding unit 106. During the normal play mode, the trick mode video bitstream is consumed at the bitstream selector 111 and the trick mode video bitstream and the original video bitstream are synchronized to each other using time stamps, such as presentation time stamps (PTS) and decode time stamps (DTS), in the video bitstreams. This allows switching from a normal play mode to a trick mode at the corresponding locations of the original and trick mode video bitstreams. During the normal play mode, the trick mode video bitstream is not decoded. Alternatively, switching can be done on the basis of index tables which index the corresponding frame locations of the bitstreams against one another, hence allowing switching from one stream to the other. Indexing can be done coarsely, e.g., location of one predictive frame per GOP will be indexed.

During a trick mode, the bitstream selector 111 switches from transmitting only the original video bitstream for decoding to transmitting only the independent reference I frames of the original video bitstream and the predictive B and P frames of the trick mode video bitstream for decoding. The frames that are displayed during a trick mode are the I frames decoded from the original video frames and the B and P frames decoded from the trick mode video frame.

The types of decoders 112 included in the decoding unit 106 depend on the codec format(s) of the original video bitstream and the trick mode video bitstream. As an example, if the original video bitstream is a video bitstream according to H.264 standard, then one of the decoders 112 is a H.264 decoder. In addition, if the trick mode video bitstream is a video bitstream according to AVS and/or VC-1 standards, the decoders 112 may include an AVS decoder and/or a VC-1 decoder.

The optional prescaler 108 is connected to the decoding unit 106 to receive the frames that are to be displayed during a trick mode. If the trick mode video bitstream was created at a lower resolution and the decoded video frames during a trick mode are to be displayed according to the display resolution of a display device (not shown), the prescaler 108 operates to appropriately scale the low resolution frames from the decoding unit 106. However, if the trick mode video bitstream was created at a lower resolution and the decoded video frames during a trick mode are to be displayed according to the lower resolution of the trick mode video bitstream, then the prescaler 108 is not needed in the system.

The mode controller 110 is connected to the various components of the system 100 to control these components. In particular, the mode controller 110 is connected to the decoding unit 106 to facilitate the switching between the normal mode and the trick modes. In some embodiments, the mode controller 110 may be implemented as part of a processor or a microcontroller. The mode controller 110 can be implemented as software, hardware, or in any combination of software, hardware and firmware.

In operation, an original video bitstream is received and stored in the storage device 102. The original video bitstream may be a video bitstream encoded according to H.264 standard or any other coding standard or standards. The original video bitstream is then accessed by the trick mode bitstream generator 104, which uses the original video bitstream to create and store a trick mode video bitstream. The trick mode video bitstream is created to be less complex with respect to decoding than the original video bitstream. The trick mode video bitstream may be created at a lower resolution than the original video bitstream and/or created according to a less complex video coding format than that of the original video bitstream.

During a normal play mode, the independent reference I frames and the predictive B and P frames of the original video bitstream are decoded by the decoding unit 106 to produce video frames to be displayed. In addition, the trick mode video bitstream is consumed by the decoding unit 106 to synchronize the trick mode video bitstream with the original video bitstream so that switching or selecting between the two bitstreams can be done seamlessly. However, the trick mode video bitstream is not decoded by the decoding unit 106 during the normal play mode.

When switched to a trick mode, only the independent reference I frames of the original video bitstream are decoded by the decoding unit 106. In addition, the predictive B and P frames of the trick mode video bitstream are decoded. The decoded independent reference I frames of the original video bistream and the decoded predictive B and P frames of the trick mode video bitstream are the video frames to be displayed during the trick mode. The decoded predictive B and P frames of the trick mode video bitstream may be upscaled by the optional prescaler 108 before being displayed.

When switched back to the normal play mode, the independent reference I frames and the predictive B and P frames of the original video bitstream are again decoded by the decoding unit 106 to produce video frames to be displayed. The trick mode video bitstream is no longer decoded by the decoding unit 106. However, the trick mode video bitstream is again consumed by the decoding unit 106 to synchronize the trick mode video bitstream with the original video bitstream so that subsequent switching or selecting between the two bitstreams can be done seamlessly.

A method for providing trick modes in accordance with an embodiment of the invention is described with reference to a process flow diagram of FIG. 3. At block 302, a trick mode video bitstream is generated from an original video bitstream. The trick mode video bitstream is of lower complexity with respect to decoding than the original video bitstream. At block 304, only the original video bitstream is decoded during a normal play mode to produce normal video frames to be displayed. At block 306, the trick mode video bitstream and a portion of the original video bitstream are decoded during a trick mode to produce trick mode video frames to be displayed.

Although the operations of the method herein are shown and described in a particular order, the order of the operations of the method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention that have been described or depicted include several components described or depicted herein, other embodiments of the invention may include fewer or more components to implement less or more functionality.

Although specific embodiments of the invention have been described and depicted, the invention is not to be limited to the specific forms or arrangements of parts so described and depicted. The scope of the invention is to be defined by the claims appended hereto and their equivalents.

What is claimed is:

1. A system for providing trick mode comprising:
a trick mode bitstream generator configured to generate a trick mode video bitstream from an original video bitstream, the trick mode video bitstream being of lower complexity with respect to decoding than the original video bitstream;
a storage device to store the original video bitstream and the trick mode video bitstream;
a decoder unit connected to the storage device to receive both the original video bitstream and the trick mode bitstream to produce decoded video frames to be displayed, the decoder unit being configured to decode only the original video bitstream to produce the decoded video frames during a normal play mode, the decoder unit being further configured to decode the trick mode video bitstream and a portion of the original video bitstream to produce the decoded video frames during a trick mode; and
a mode controller connected to the decoder unit to control the decoder unit to decode according one of the normal play mode and the trick mode in response to user input.

2. The system of claim 1 wherein the trick mode bitstream generator is configured to generate the trick mode video bitstream at a lower resolution than the resolution of the original video bitstream.

3. The system of claim 1 wherein the trick mode bitstream generator is configured to generate the trick mode video bitstream according to a video coding format that is different than a video coding format of the original video bitstream.

4. The system of claim 1 wherein the trick mode bitstream generator is configured to generate the trick mode video bitstream as at least one multi-codec video bitstream.

5. The system of claim 4 wherein the at least one multi-codec video bitstream includes a multi-codec data header that comprises a unique identifier and a codec type.

6. The system of claim 4 wherein the trick mode bitstream generator is configured to store the trick mode video bitstream in the storage device as a single multi-codec video bitstream or as multiple multi-codec video bitstreams.

7. The system of claim 1 wherein the trick mode bitstream generator is further configured to store the trick mode video bitstream as part of a composite video bitstream that includes the trick mode video bitstream and the original video bitstream.

8. The system of claim 1 wherein the decoding unit is configured to decode only independent reference frames of the original video bitstreams during the trick mode such that only the independent reference frames decoded from the original video bitstreams and predictive frames decoded from the trick mode bitstream are produced to be displayed.

9. The system of claim 1 wherein the decoding unit is configured to synchronize the trick mode video bitstream with the original video bitstream during the normal play mode using time stamps in the trick mode video bitstream so that switching from the normal play mode to the trick mode can occur at corresponding locations of the original and trick mode video bitstreams.

10. A method for providing trick modes, the method comprising:
generating a trick mode video bitstream from an original video bitstream, the trick mode video bitstream being of lower complexity with respect to decoding than the original video bitstream;
decoding only the original video bitstream during a normal play mode to produce normal video frames to be displayed; and
decoding the trick mode video bitstream and a portion of the original video bitstream during a trick mode to produce trick mode video frames to be displayed.

11. The method of claim 10 wherein the generating the trick mode video bitstream includes generating the trick mode video bitstream at a lower resolution than the resolution of the original video bitstream.

12. The method of claim 10 wherein the generating the trick mode video bitstream includes generating the trick mode video bitstream according to a video coding format that is different than a video coding format of the original video bitstream.

13. The method of claim 10 wherein the generating the trick mode video bitstream includes generating the trick mode video bitstream as at least one multi-codec video bitstream.

14. The method of claim 13 wherein the at least one multi-codec video bitstream includes a multi-codec data header that comprises a unique identifier and a codec type.

15. The method of claim 13 wherein the generating the trick mode video bitstream includes storing the trick mode video bitstream as a single multi-codec video bitstream or as multiple multi-codec video bitstreams.

16. The method of claim 10 wherein the generating the trick mode video bitstream includes storing the trick mode video bitstream as part of a composite video bitstream that includes the trick mode video bitstream and the original video bitstream.

17. The method of claim 10 wherein the decoding only the original video bitstream includes decoding only independent reference frames of the original video bitstreams during the trick mode such that only the independent reference frames decoded from the original video bitstreams and predictive frames decoded from the trick mode bitstream are produced to be displayed.

18. The method of claim 10 further comprising synchronizing the trick mode video bitstream with the original video bitstream during the normal play mode using time stamps in the trick mode video bitstream so that switching from the normal play mode to the trick mode can occur at corresponding locations of the original and trick mode video bitstreams.

19. A method for providing trick modes, the method comprising:
generating a trick mode video bitstream from an original video bitstream, the trick mode video bitstream being of lower complexity with respect to decoding than the original video bitstream;
decoding only the original video bitstream during a normal play mode to produce normal video frames to be displayed; and
decoding predictive frames of the trick mode video bitstream to and independent reference frames of the original video bitstream during a trick mode to produce trick mode video frames to be displayed.

20. The method of claim 19 wherein the generating the trick mode video bitstream includes generating the trick mode video bitstream at a lower resolution than the resolution of the original video bitstream and according to a video coding format that is different than a video coding format of the original video bitstream.
